(19) United States
(12) Patent Application Publication
(10) Pub. No.: US 2013/0312690 A1
(43) Pub. Date: Nov. 28, 2013

(54) METHOD FOR DETERMINING THE ALCOHOL CONTENT OF A NEW FUEL MIXTURE IN THE INTERNAL COMBUSTION ENGINE OF A VEHICLE, AND DEVICE FOR IMPLEMENTING SAME

(71) Applicant: Jean-Paul Ferrie, Rieumes (FR)

(72) Inventor: Jean-Paul Ferrie, Rieumes (FR)

(73) Assignee: CONTINENTAL AUTOMOTIVE FRANCE, Toulouse (FR)

(21) Appl. No.: 13/981,696

(22) PCT Filed: Jan. 17, 2012
(86) PCT No.: PCT/EP12/00168

§ 371 Date: Jul. 25, 2013

(30) Foreign Application Priority Data
Jan. 28, 2011 (FR) 1100255

(51) Int. Cl. F02B 43/00

(52) U.S. Cl. CPC F02B 43/00
USPC 123/1 A

(57) ABSTRACT

A method for determining the alcohol content of a fuel mixture for a vehicle internal combustion engine that can be sequentially supplied with two types of fuel having a predetermined composition, at least one of which contains a mixture of gasoline and alcohol, includes, after feeding an amount of new fuel into the vehicle tank previously containing an amount of old fuel mixture, determining the first moment at which the new fuel mixture is supplied to the first injector. After the first moment, and from the first sufficiently long period during which the operating state of the engine is stabilized, determining an optional variation trend of the richness of the air/fuel mixture relative to a previously measured richness, deducing the type of new fuel supplied and, by cross-checking this information with the respective volumes of old and new fuels in the tank, determining the alcohol content of the new mixture.

The present invention relates to a method for determining the alcohol content in a fuel mixture of an internal combustion engine of a vehicle known as flexible fuel vehicle (FFV), and a device for implementing such a method. An FFV should be understood to be a vehicle that can operate with different types of fuels having a predetermined composition, consisting of a mixture of gasoline and alcohol in variable proportions. The invention also relates to a method for regulating the operation of such an engine, implementing the steps of the abovementioned method for determining the alcohol content of a fuel mixture.

The number of flexible fuel vehicles on the road is increasing. The engines of these vehicles are generally designed according to the geographic area (country, continent, etc.) for which they are intended. Generally, each geographic area has two main types of fuels intended for these vehicles. Thus, for example, in European countries, the two types of fuel available at the pump are gasoline and a mixed fuel comprising a proportion of ethanol of between 7 and 85% (denoted E85 to indicate that the fuel contains up to 85% of alcohol), according to the country. In other countries, such as Brazil, the two types of fuel available are mixed and respectively comprise approximately 20% (E20) and 100% (E100) ethanol.

The correct operation of the internal combustion engine of the flexible fuel vehicles requires a precise knowledge of the alcohol proportion contained in the fuel which is introduced into the engine by the fuel injectors (for example). This alcohol proportion in fact influences the stoichiometric data of the combustion, and the quantity of fuel injected has to take it into account. A bad estimation of this proportion leads in particular to engine malfunctions such as jerky acceleration and deceleration, risks of stalling, inability to start, etc.

Now, the precise knowledge of the alcohol proportion present in a fuel is made more complicated by the fact that the vehicle is supplied sequentially with fuels having different alcohol contents. In practice, the new fuel is introduced into a fuel tank of the vehicle already containing a certain volume of old fuel mixture of which the alcohol content is potentially different from that of the new fuel.

There are currently various methods for estimating the alcohol content of a new fuel mixture arriving at the internal combustion engine of the vehicles.

A first method consists in evaluating this alcohol content by means of a specific sensor, arranged upstream of the engine injection rail in the fuel circulation circuit. Said sensor operates on the principle of measuring the electrical conductivity of the fuel. This electrical conductivity is variable as a function of the alcohol proportion contained in the fuel. Such a sensor is, however, relatively costly and its installation in the vehicle consequently involves a cost overhead in the manufacture thereof.

Another method currently applied consists in measuring the combustion richness by means of a specific sensor such as a lambda probe, arranged downstream of a vehicle exhaust manifold. The duly measured combustion richness value makes it possible to estimate the alcohol content of the fuel. The procedure normally used is as follows.

The lambda probes installed are probes that give a binary signal (two output levels depending on whether the gaseous mixture analyzed is above or below the setpoint value) and not linear probes. The binary output signal therefore toggles from one state to the other over time according to the measured values. This beating of the binary signal from the lambda probe is integrated over a certain period of time by a computer in order to determine the combustion richness of the gaseous mixture. This integration usually takes some time to become stable (values of 5 to 10 seconds are commonplace). Once the integration is stable, if the operating conditions of the engine are correct (the integration being disturbed by any modification of the position of the accelerator pedal will without fail generate a fluctuation in the engine speed), then the combustion richness variation is determined.

Once the combustion richness variation is known, a second integration is carried out to estimate the alcohol proportion. This second integration takes a very long time (approximately 180 seconds). Just like the first integration, this second integration intended to estimate the alcohol proportion is disturbed, or even stopped, by any variation of the engine speed generated by a change of position of the accelerator pedal. Its estimated value is therefore greatly affected and, without a 180-second time sequence at stabilized engine speed, said estimation is random.

It is this 180-second time sequence at stabilized engine speed that the present invention sets out to eliminate. In fact, in practice, and in particular in the conditions of use of the vehicle in a town (where the vehicle is subject to frequent successive slowing-down and speeding-up phases) or of apprehensive or of sporty driving, such a stabilized engine speed duration is sometimes obtained only after several tens of minutes of operation, sometimes long after the new fuel mixture formed in the tank has reached the injectors. In the meantime, the engine may consequently be subject to malfunctions, such as those mentioned above.

The present invention aims to remedy the drawbacks of the existing methods for determining the alcohol content of a new fuel mixture in an internal combustion engine of an flexible fuel vehicle, in particular the drawbacks described above, by proposing a method which makes it possible to determine the alcohol content of the new fuel mixture quickly, so as to limit, or even eliminate, the malfunctions of the engine caused by the introduction into the tank of a fuel whose alcohol content is different from that of the fuel already present.

The invention also aims for this method to be associated with a low cost overhead in the production of the vehicles equipped with the means with which to implement it.

To this end, there is proposed, according to the present invention, a method for determining the alcohol content of a fuel mixture in an internal combustion engine of a vehicle that can be successively supplied with fuel by two types of fuel having a predefined composition, at least one of which contains a mixture of gasoline and alcohol. This engine is of the type comprising, conventionally in itself, a plurality of injectors supplied with fuel from an injection rail. The fuel mixture is obtained by the introduction of a new fuel into a fuel tank of the vehicle already containing an old fuel mixture.

According to this method:
a) Prior to the step of introduction of a volume of new fuel into the tank, the volume of the old fuel mixture and the alcohol content of the old fuel mixture, called initial alcohol content, are estimated.
b) After this step of introduction, the volume of new fuel introduced into the tank is estimated.
c) After the engine is started up following said introduction, the first instant from which the mixture of new fuel and of old fuel mixture arrives, from the tank, at the first injector is determined.
d) After said first instant, from the first period of stabilized engine operating speed that is long enough for this purpose, an examination is made to see if the combustion richness varies relative to a richness measurement recorded prior to said first instant. The observation of a richness variation indicates that the new fuel introduced into the tank has an alcohol content different to that of the old fuel mixture. If it does, the direction of variation of said richness is determined.
e) From the duly determined richness variation, and from the initial alcohol content, the type of the new fuel introduced into the tank is deduced.
f) And from the information concerning the duly deduced type of new fuel, and from the volume values respectively of old fuel mixture and of new fuel in the tank, the so-called final alcohol content of the mixture of the old fuel mixture and of the new fuel is calculated.

Such a method according to the present invention advantageously makes it possible to determine the alcohol content of the new fuel mixture formed in the tank very rapidly after the vehicle is started up after refilling the tank, and notably much more rapidly than by the methods of the prior art.

Such rapidity is made possible by the fact that the method according to the invention advantageously uses a simple estimation of the direction of the drift in combustion richness attributable to the presence of a new fuel mixture in the engine. Unlike the methods of the prior art, it does not require an exact measurement of a new combustion richness, which is a measurement that requires a much longer period of stabilized engine operating speed to obtain a result that is reliable enough to be able to derive information from it that is correct in terms of the alcohol content of the new fuel mixture.

Furthermore, the present invention makes it possible to dispense with a sensor for specifically measuring the alcohol content of the fuel, which adds costs.

In preferred implementations of the invention, the period of stabilized engine operating speed has a duration of between 10 and 20 seconds. Such a short duration is advantageously sufficient to obtain reliable information on the direction of any variation of combustion richness induced by the introduction of a fuel of a new type into the tank of the vehicle, compared to a combustion richness associated with the old fuel mixture. Cross-referencing this information with that of the known predefined composition of each type of fuel likely to have been introduced into the tank of the vehicle, then with that of the volume of new fuel introduced, and that of the volume of the old fuel mixture that was already present therein, makes it possible, by simple calculations, to determine the alcohol content of the duly obtained fuel mixture. This alcohol content can also advantageously be determined very early after start-up, as soon as the new fuel mixture reaches the first injector (an instant also called “first instant” in this text), and straight after the subsequent first period of stabilized speed of approximately 10 to 20 seconds. In practice, such a period of stabilized speed of approximately 10 seconds is likely to occur very rapidly after the first instant, even before the new fuel mixture has reached the second injector.

The method according to the invention is also advantageously capable of being implemented by means already installed conventionally per se on the vehicle, so that the cost overhead associated with its implementation is low.

A device for implementing the method according to the invention thus comprises a sensor for measuring combustion richness and means configured to implement steps a) to f) described previously.

In particular, the combustion richness is preferably estimated by means of a lambda probe that is conventional per se, arranged downstream of an exhaust manifold of the vehicle.

The respective volumes of old fuel mixture present in the tank and of new fuel that is introduced therein can be estimated by means of a detector of the fuel level in the tank also routinely installed on existing vehicles.

The alcohol content of the old fuel mixture can be determined by usual methods, notably from a richness measurement recorded while the vehicle is operating, prior to the introduction of the new fuel. This prior richness measurement can also be used as a comparison in order to subsequently determine the direction of richness variation that can be attributed to the new fuel introduced into the tank.

The various steps of calculating and storing the information are preferably performed by the engine computer of the vehicle. This engine computer is preferably of the programmed computer type, comprising at least one microprocessor, and storage means (magnetic hard disk, so-called “flash” memory, optical disk, etc.) in which is stored a computer program, in the form of a set of program code instructions to be executed to implement the various calculation steps of the method for determining the alcohol content of the new fuel mixture according to the invention. According to certain embodiments, the calculation device also comprises one or more dedicated integrated circuits, of FPGA type (FPGA standing for Field Programmable Gate Array, i.e. an in situ array of programmable gates), of CPLD (Complex Programmable Logic Device) type, and so on, suitable for implementing all or some of the calculation steps of the method.

According to preferred implementations of the invention, the determination of the instant at which the mixture of old fuel mixture and of new fuel arrives, from the tank, at a given injector, is obtained by a modeling of the fuel transfer from the tank to that injector. The calculation model used notably takes into account, for each given vehicle, on the one hand fixed structural parameters, such as the dimensions of the fuel circuit between the tank and the injector, and, on the other hand, variable operating parameters, such as the fuel consumption of each injector of the vehicle.

Thus, according to the invention, a model for calculating the time taken by the new fuel mixture to arrive from the tank at a given injector of an internal combustion engine comprising a plurality of injectors contains a first and a second component.

The first component, denoted Tbp, to express the transfer time of the fuel associated with the low pressure pump of the vehicle, that is to say, the transfer time of the fuel from the pump input to the pressurized output of the low pressure regulator, is estimated by the equation:

Tbp=Vcircuit/Q_{P},

in which
Q_{P} is the throughput of the pump at operating pressure, and
Vcircuit is the volume of fuel present between the pump input and the regulator output.

In particular, Q_{P} is a constant associated with the particular pump implemented.

The second component, denoted Tcm₁ to express the transfer time of the fuel between the regulator output and the output to the first injector, is estimated by the equation:

Tcm₁=Vrail₁/sum (Qi₁+Qi₂+ . . . +Qiₓ)

in which
Vrail₁ is the sum of the volume of fuel between the pressure regulator and the input of the injection rail, on the one hand, and of the volume of fuel in the injection rail upstream of the first injector, on the other hand,
Qi₁ is the rate of consumption of the engine on the first injector,
Qi₂ is the rate of consumption of the engine on the second injector reached by the fuel, and so on.

The time taken by the new fuel mixture to arrive from the output of the injector iₙ₋₁ at the output of the injector iₙ of an internal combustion engine comprising a plurality of injectors i₁ to iₓ, can be estimated by the calculation model:

Tcmₙ=Vrailₙ/sum (Qiₙ+Qiₙ₊ᵢ+ . . . +Qiₓ)

in which
Vrailₙ is the volume of fuel in the injection rail between the output to the injector iₙ₋₁ and the output to the injector iₙ,
Qiₙ is the rate of consumption of the engine on the injector iₙ,
Qiₙ₊₁ is the rate of consumption of the engine on the injector iₙ₊₁, and so on.

Another aspect of the invention is a method for regulating the operation of an internal combustion engine of a vehicle that can be sequentially supplied with fuel by two types of fuel having a predefined composition, at least one of which contains a mixture of gasoline and alcohol, this engine comprising a plurality of injectors supplied with fuel from an injection rail. This method is characterized in that, for each new introduction of a new fuel into a fuel tank of the vehicle already containing an old fuel mixture, leading to the formation in the tank of a new fuel mixture:
the method for determining the alcohol content of the new fuel mixture according to the invention, as described above, is applied, so as to determine the so-called final alcohol content of the mixture of the old fuel mixture and of the new fuel,
in parallel, after the engine has been started up following said introduction, for each injector, the instant from which the mixture of old fuel mixture and of new fuel arrives, from the tank, at said injector is determined,
and, as soon as the final alcohol content of the new fuel mixture is determined, for each injector in which it is estimated that the new fuel mixture has already arrived, a correction to the quantity of fuel injected is applied taking into account this final alcohol content.

The appropriate correction is determined by conventional calculations, well within the scope of the person skilled in the art.

Thus, as soon as the alcohol content of the new fuel mixture is determined, that is to say, as has been explained above, very rapidly after this new mixture has arrived at the first injector, this method advantageously ensures that a correction of the injection time, for example, is applied to each injector already receiving the new mixture. This correction can be accompanied by other actions associated with engine control, such as modification of the ignition advance for example.

In preferred implementations of the invention, for each injector in which it is estimated that said fuel mixture has not yet arrived when the final alcohol content of the new fuel mixture is determined, said correction is applied from the corresponding instant.

According to the method of the invention, an injection correction, for example, taking into account the value of the alcohol content of the new fuel mixture is consequently applied to each injector in turn, as soon as this value is known or as soon as the new mixture arrives there, depending on the cases.

In that, the method for regulating the operation of an engine according to the invention proves much more advantageous than the methods proposed by the prior art, which do nothing more than simultaneously apply the same injection correction to all the injectors, without differentiating them from one another, and mostly when the new fuel mixture has already been arriving at all the injectors for several minutes. On the contrary, the method according to the invention ensures that the combustion richness is corrected cylinder by cylinder, almost as soon as the new fuel mixture arrives at the associated injector.

An additional aspect of the invention is a device for implementing the method for regulating the operation of an engine as described above, which, in addition to the components of the device for implementing the method for determining the alcohol content of the new fuel mixture described above, comprises means suitable for calculating an injection correction as a function of the alcohol content of the mixture, and for applying said correction to each injector at the appropriate instant as defined above.

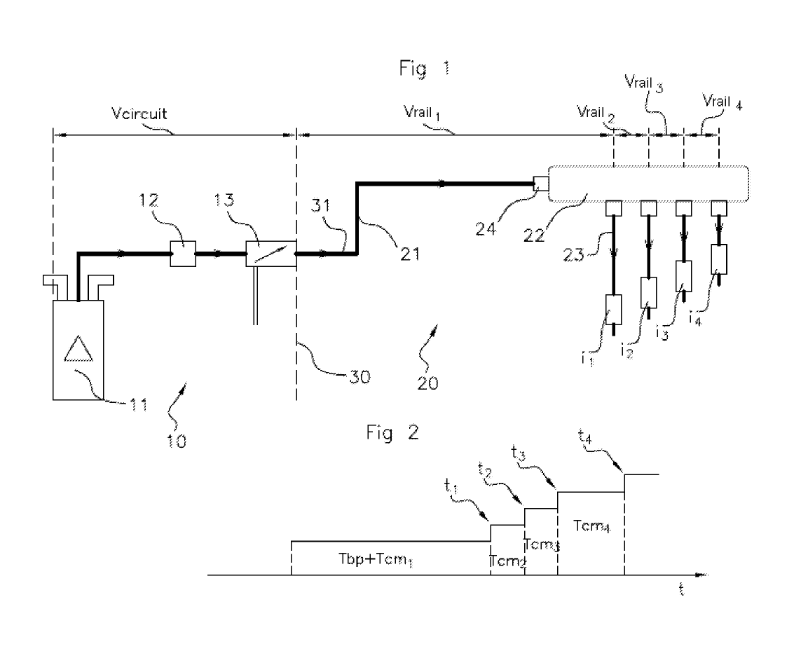

The invention will now be described more specifically in the context of preferred implementations, which are in no way limiting, represented in FIGS. 1 and 2, in which:

FIG. 1 schematically represents a fuel circuit between the output of a fuel tank and the injectors of a vehicle with internal combustion engine;

and FIG. 2 shows an exemplary diagram illustrating the fuel transfer in the circuit of FIG. 1 as a function of time.

A conventional fuel circuit of a vehicle with internal combustion engine with flexible fuel comprises, as illustrated in FIG. 1, a first part 10 in which the circulation of the fuel is controlled by a low pressure pump 11, and a second part 20 in which this circulation is governed by the consumption of an engine.

These two parts are artificially represented separated from one another, for the purposes of understanding the figure, by a demarcation line 30.

The first part 10 comprises, in addition to the low pressure pump 11, components that are conventional per se such as a filter 12 and a low pressure regulator 13.

The direction of circulation of the fuel in the circuit is illustrated by arrows 31. From the fuel tank, which is not represented in the figure, the fuel is driven by the low pressure pump 11, through the filter 12 and then the regulator 13, whence it is then brought, in a pipe 21, to the injection rail 22.

The injection rail supplies fuel to a plurality of injectors. In a particular embodiment represented by way of illustration in the figure, there are four of the injectors, denoted i₁ to i₄. The present invention is not however limited to such a number of injectors.

From the injection rail, the injectors, which are connected thereto in parallel, are supplied sequentially, via connecting pipes 23.

Thus, when a new fuel mixture arrives at the injection rail 22, at an end 24 thereof linked to the fuel supply pipe 21, it is first of all brought to the injector i₁ arranged in the first place after this end 24. The mixture then arrives, with a time offset, at the second injector i₂, then at the third injector i₃, and finally at the fourth injector i₄. The instant t₄ at which the new fuel mixture arrives at the last injector i₄ is generally offset by 2 to 3 minutes relative to the instant t₁ at which it arrives at the first injector i₁.

According to one implementation of a method for determining the alcohol content of a new fuel mixture in an internal combustion engine, the fuel transfer from the fuel tank of the vehicle, to each of the injectors i₁ to i₄, can be modeled from the following equations:
Transfer time Tbp of the fuel from the input of the pump 11 to the pressurized output of the regulator 13:

Tbp=Vcircuit/Q_{P}

in which Q_{P} is the throughput of the pump 11 under operating pressure and Vcircuit is the volume of fuel present between the input of the pump 11 and the output of the regulator 13,
Transfer time of the fuel between the output of the regulator 13 and the output to the injector i₁:

Tcm₁=Vrail₁/sum (Qi₁+Qi₂+Qi₃+Qi₄)

in which Vrail₁ is the sum of the volume of fuel between the regulator 13 and the injection rail 22 and of the volume of fuel in the injection rail upstream of the output to the injector i₁, Qi₁ is the rate of consumption of the engine on the injector i₁, Qi₂ is the rate of consumption of the engine on the injector i₂, and so on,
Transfer time of the fuel between the output to the injector i₁ and the output to the injector i₂:

Tcm₂=Vrail₂/sum (Qi₂+Qi₃+Qi₄)

in which Vrail₂ is the volume of fuel in the injection rail between the output to the injector i₁ and the output to the injector i₂, Qi₂ is the rate of consumption of the engine on the injector i₂, Qi₃ is the rate of consumption of the engine on the injector i₃, and so on,
Transfer time of the fuel between the output to the injector i₂ and the output to the injector i₃:

Tcm₃=Vrail₃/sum (Qi₃+Qi₄)

in which Vrail₃ is the volume of fuel in the injection rail between the output to the injector i₂ and the output to the injector i₃, Qi₃ is the rate of consumption of the engine on the injector i₃ and Qi₄ is the rate of consumption of the engine on the injector i₄,
Transfer time of the fuel between the output to the injector i₃ and the output to the injector i₄:

Tcm₄=Vrail₄/Qi₄

in which Vrail₄ is the volume of fuel in the injection rail between the output to the injector i₃ and the output to the injector i₄ and Qi₄ is the rate of consumption of the engine on the injector i₄.

These various volumes are schematically illustrated in FIG. 1.

Thus, from the tank, the instant t₁ (also called “first instant” in this text) at which a new fuel mixture formed in the tank arrives at the injector i₁, is reached after a time equal to Tbp+Tcm₁. The instant t₂ at which a new fuel mixture formed in the tank arrives at the injector i₂ is reached after a time equal to Tbp+Tcm₁+Tcm₂, and so on.

The transfer time of the fuel in the pipes 23 is, for its part, preferably considered to be negligible.

These different transfer times and instants tₙ at which the new fuel mixture arrives at a given injector iₙ, where n is equal to 1, 2, 3 or 4, are illustrated in the diagram of FIG. 2. In this diagram, each instant tₙ at which the new fuel mixture arrives at a new injector iₙ, is represented by a discontinuity on the time curve.

The diagram of FIG. 2 corresponds to a real case of driving, for a given vehicle, of predetermined fixed structural characteristics (Vcircuit and Vrailₙ, where n is equal to 1, 2, 3 or 4), for given operating parameters.

As an example, Tbp+Tcm₁ is equal to approximately 269 seconds, Tcm₂ to approximately 19 seconds, Tcm₃ to approximately 56 seconds and Tcm₄ to approximately 94 seconds.

An exemplary implementation of a method for determining the alcohol content of a new fuel mixture in an internal combustion engine, that conforms to the present invention, will be described below, with examples of values of the different parameters chosen for purely illustrative purposes, and in no way limiting on the present invention.

In this example, it is considered that the vehicle is likely to be supplied with fuel by two types of fuel which are E20, comprising an alcohol content of 20%, and E100, comprising an alcohol content of 100%.

We also start from the assumption that the old fuel mixture present in a fuel tank of the vehicle comprises an alcohol content of 61%. This content can be evaluated, prior to the method according to the invention, in a way that is perfectly conventional in itself, for example by a richness measurement performed by a lambda probe arranged downstream of an exhaust manifold of the vehicle. A richness measurement representative of this alcohol content of 61% is also stored in an engine computer of the vehicle.

Prior to the introduction of a new fuel into the tank, a value of the volume of old fuel mixture present in the tank, obtained from a measurement of fuel level in the tank, is recorded and stored by a sensor that is conventional in itself arranged in the tank. This volume is, for example, equal to 10 liters.

After the introduction of a volume of new fuel into the tank, the fuel level in the tank is recorded again, and the volume of new fuel introduced is deduced therefrom, by simple calculations that are within the scope of the person skilled in the art. This volume is, for example, equal to 4.26 liters.

A new mixture of old fuel mixture and of new fuel, for which the present method aims to determine the alcohol content, is formed in the tank.

After the engine is started up following the introduction of the new fuel into the tank, the model described above is used to determine the instant t₁ at which the new mixture arrives at the fist injector i₁. This instant t₁ is schematically represented in the diagram of FIG. 2 by a first discontinuity. From this instant, there is a wait until a period of stabilized engine operating speed of between 10 and 20 s is observed, which is long enough to be able to obtain an estimation of a direction of drift in combustion richness.

As an example, such a determination can be made before the instant t₂ at which the new fuel mixture arrives at the second injector i₂. A richness measurement corresponding to a theoretical alcohol content of 67% is obtained. This measurement is not reliable, because it is carried out over a period of stabilized speed that is too short for this purpose, but it does nevertheless give an indication as to the direction of variation of combustion richness, which is increasing, and which consequently indicates that the new fuel comprises an alcohol content greater than that of the old fuel mixture. The method according to the invention advantageously exploits this information, by cross-referencing it with other information that is directly available.

Thus, it is deduced that the new fuel is E100. By cross-referencing this information with the respective volumes of old fuel mixture and of new fuel in the tank, it is then determined that the alcohol content of the new fuel mixture is equal to 87%.

This alcohol content is thus advantageously determined very early after the new fuel mixture has arrived at the first injector i₁, and often even before it has arrived at the second injector i₂.

All of these calculation and storage steps are preferably implemented by the engine computer of the vehicle, which requires only simple software adaptations compared to the computers pre-existing on the vehicles.

A more holistic method for regulating the operation of an engine according to the invention implements the above steps for determining the alcohol content of the new fuel.

It adds to it the determination, made in parallel, of the instant tₙ at which the fuel mixture arrives at each given injector iₙ. This is done by means of the fuel transfer model described above. Thus, at each given instant t, it is possible to determine, as a function of the quantity of fuel injected, whether the new fuel mixture has or has not arrived at a given injector iₙ.

As soon as the alcohol content is determined, a correction is applied, for each injector at which it is estimated that the new mixture has arrived, to the quantity of fuel injected. This correction is determined, conventionally in itself to the person skilled in the art, as a function of the alcohol content of the mixture.

For each injector iₙ at which the new fuel mixture has not yet arrived, this same correction is applied from the corresponding instant tₙ.

The correction is thus advantageously applied to each injector in turn, at the most appropriate instant for each, as a function of the moment when the alcohol content of the new mixture has been able to be determined, which as has been explained above in this description, is very rapid.

The risks of engine malfunction are thereby limited in the period following the introduction of a new fuel into the tank.

The above description clearly illustrates that, by its various features and their advantages, the present invention achieves the objectives that were set for it. In particular, it provides a method for determining the alcohol content of a new fuel mixture in an internal combustion engine of a vehicle with flexible fuel, as well as a more holistic method for regulating the operation of such an engine, which are quick to set up and whose implementation requires only very few modifications to the current systems installed on the vehicles, these modifications additionally being mainly of software type (no use of a costly sensor for measuring the percentage of alcohol). Consequently, these methods can be implemented with only a small additional cost. These methods according to the invention make it possible to avoid, even eliminate, the occasional risks of engine malfunction caused by the introduction into the tank of the vehicle of a fuel whose alcohol content is different from the alcohol content of the fuel that was already there.

Furthermore, the invention is adapted easily to each case of fuels used in a given geographic area since it can be applied to any type of alcohol and gasoline fuel mixture, ranging from pure gasoline (E0) to pure alcohol (E100).

1. A method for determining the alcohol content of a fuel mixture in an internal combustion engine of a vehicle that can be sequentially supplied with fuel by two types of fuel (C₁; C₂) having a predefined composition, at least one of which contains a mixture of gasoline and alcohol, said engine comprising a plurality of injectors (i₁; iₓ) supplied with fuel from an injection rail, and said fuel mixture being obtained by the introduction of a new fuel into a fuel tank of the vehicle already containing an old fuel mixture, whereby:
a) prior to the step of introduction of a volume of new fuel into said tank, the volume of the old fuel mixture and the alcohol content of said old fuel mixture, called initial alcohol content, are estimated,
b) after said introduction, the volume of new fuel introduced into said tank is estimated,
c) after the engine is started up following said introduction, the first instant (t₁) from which the mixture of old fuel mixture and of new fuel arrives, from the tank, at the first injector (i₁) is determined,
d) after said first instant (t₁), from the first period of stabilized engine operating speed that is long enough for this purpose, an examination is made to see if the combustion richness varies relative to a richness measurement recorded prior to the instant (t₁), and, if it does, the direction of variation of said richness is determined,
e) from the duly determined richness variation, and from the initial alcohol content, the type of the new fuel introduced into the tank is deduced,
f) and from the information concerning the duly deduced type of new fuel, and from the volume values respectively of old fuel mixture and of new fuel in the tank, the so-called final alcohol content of the mixture of the old fuel mixture and of the new fuel is calculated.

2. The method as claimed in claim 1, characterized in that said period of stabilized engine operating speed is between 10 and 20 seconds.

3. The method as claimed in claim 1, characterized in that the richness measurement is carried out by means of a lambda probe arranged downstream of an exhaust manifold of the vehicle.

4. A device for implementing a method as claimed in claim 1, characterized in that it comprises a sensor for measuring combustion richness and means configured to implement steps a) to f).

5. A method for regulating the operation of an internal combustion engine of a vehicle that can be sequentially supplied with fuel by two types of fuel (C₁; C₂) having a predefined composition, at least one of which contains a mixture of gasoline and alcohol, said engine comprising a plurality of injectors (i₁; iₓ) supplied with fuel from an injection rail, characterized in that, for each new introduction of a new fuel into a fuel tank of the vehicle already containing an old fuel mixture, forming a new fuel mixture in said tank:
the method for determining the alcohol content of the new fuel mixture as claimed in claim 1 is applied, so as to determine the so-called final alcohol content of the mixture of the old fuel mixture and of the new fuel,
in parallel, after the engine has been started up following said introduction, for each injector (iₙ), the instant (tₙ) from which the mixture of old fuel mixture and of new fuel arrives, from the tank, at said injector (iₙ) is determined, and, as soon as the final alcohol content of the new fuel mixture is determined, for each injector in which it is estimated that said fuel mixture has already arrived, a correction to the quantity of fuel injected is applied taking into account said final alcohol content.

6. The method as claimed in claim 5, characterized in that, for each injector (iₙ) in which it is estimated that said fuel mixture has not yet arrived when the final alcohol content of the new fuel mixture is determined, said correction is applied from the corresponding instant (tₙ).

7. The method as claimed in claim 2, characterized in that the richness measurement is carried out by means of a lambda probe arranged downstream of an exhaust manifold of the vehicle.

8. A method for regulating the operation of an internal combustion engine of a vehicle that can be sequentially supplied with fuel by two types of fuel (C₁; C₂) having a predefined composition, at least one of which contains a mixture of gasoline and alcohol, said engine comprising a plurality of injectors (i₁; iₓ) supplied with fuel from an injection rail, characterized in that, for each new introduction of a new fuel into a fuel tank of the vehicle already containing an old fuel mixture, forming a new fuel mixture in said tank:
the method for determining the alcohol content of the new fuel mixture as claimed in claim 2 is applied, so as to determine the so-called final alcohol content of the mixture of the old fuel mixture and of the new fuel,
in parallel, after the engine has been started up following said introduction, for each injector (iₙ), the instant (tₙ) from which the mixture of old fuel mixture and of new fuel arrives, from the tank, at said injector (iₙ) is determined,
and, as soon as the final alcohol content of the new fuel mixture is determined, for each injector in which it is estimated that said fuel mixture has already arrived, a correction to the quantity of fuel injected is applied taking into account said final alcohol content.

9. A method for regulating the operation of an internal combustion engine of a vehicle that can be sequentially supplied with fuel by two types of fuel (C₁; C₂) having a predefined composition, at least one of which contains a mixture of gasoline and alcohol, said engine comprising a plurality of injectors (i₁; iₓ) supplied with fuel from an injection rail, characterized in that, for each new introduction of a new fuel into a fuel tank of the vehicle already containing an old fuel mixture, forming a new fuel mixture in said tank:
the method for determining the alcohol content of the new fuel mixture as claimed in claim 3 is applied, so as to determine the so-called final alcohol content of the mixture of the old fuel mixture and of the new fuel,
in parallel, after the engine has been started up following said introduction, for each injector (iₙ), the instant (tₙ) from which the mixture of old fuel mixture and of new fuel arrives, from the tank, at said injector (iₙ) is determined,
and, as soon as the final alcohol content of the new fuel mixture is determined, for each injector in which it is estimated that said fuel mixture has already arrived, a correction to the quantity of fuel injected is applied taking into account said final alcohol content.

10. The method as claimed in claim 8, characterized in that, for each injector (iₙ) in which it is estimated that said fuel mixture has not yet arrived when the final alcohol content of the new fuel mixture is determined, said correction is applied from the corresponding instant (tₙ).

11. The method as claimed in claim 9, characterized in that, for each injector (iₙ) in which it is estimated that said fuel mixture has not yet arrived when the final alcohol content of the new fuel mixture is determined, said correction is applied from the corresponding instant (tₙ).
